(19) United States
(12) Patent Application Publication
(10) Pub. No.: US 2007/0153015 A1
(43) Pub. Date: Jul. 5, 2007

(54) Graphics processing unit instruction sets using a reconfigurable cache

(75) Inventor: Tsao You-Ming, Taipei (TW)

Correspondence Address: TROXELL LAW OFFICE PLLC, SUITE 1404, 5205 LEESBURG PIKE, FALLS CHURCH, VA, 22041, US

(73) Assignee: SMedia Technology Corporation

(21) Appl. No.: 11/325,537

(22) Filed: Jan. 5, 2006

(51) Int. Cl. G09G 5/36

(52) U.S. Cl. 345/557

(57) ABSTRACT

Graphics processing unit instruction sets using a reconfigurable cache are disclosed. The Graphics processing unit instruction sets includes following elements: (1) a vertex shader unit, for operating vertex data; (2) a reconfigurable cache memory, for accessing data with the vertex shader unit via a plurality of data buses; (3) a bank interleaving, for achieving byte alignment for the reconfigurable cache memory; (4) a software control data feedback, for reducing accessing frequency of registers of the reconfigurable cache memory; and (5) a software control data write back, for determining if the data need to be written back to the registers.

### BACKGROUND OF THE INVENTION

1. Field of the Invention

The present invention relates generally to a reconfigurable cache, and more particularly, to graphics processing unit instruction sets using a reconfigurable cache. The present invention has video acceleration capability and can be applied to a portable hand-help device, such as, but not limited to, Digital Still Camera (DSC), Digital Video (DV), Personal Digital Assistant (PDA), mobile electronic device, 3G mobile phone, cellular phone or smart phone.

2. Description of the Prior Art

A reconfigurable cache memory can provide Graphics Processing Unit (GPU) that achieves most working efficiency for the flexible using of a vertex buffer in vertex calculations. Furthermore, the reconfigurable cache memory can be reconfigured to a search range buffer of video compact standard in motion estimations. In addition, programmability of the GPU can substantially increase speeds of the motion estimations for using the GPU to compact video data and achieve most resource sharing of hardwares. The reconfigurable cache memory can reduce manufacturing costs and save the power of calculations for general mobile multimedia platforms.

There are four sets of registers including vertex input registers, vertex output registers, constant registers and temporary registers in a conventional Graphics Processing Unit architecture. The number of each of the four sets of registers is invariable and cannot be changed. However, all applications will use the four sets of registers completely resulting in inefficient work.

Therefore, a novel architecture for the purpose of using efficiency of the four sets of registers is urged.

### SUMMARY OF THE INVENTION

An objective of the present invention is to solve the above-mentioned problems and to provide graphics processing unit instruction sets using a reconfigurable cache that accelerates motion estimation in video coding.

The present invention achieves the above-indicated objective by providing graphics processing unit instruction sets using a reconfigurable cache. The graphics processing unit instruction sets using a reconfigurable cache includes following elements: (1) a vertex shader unit, for operating vertex data; (2) a reconfigurable cache memory, for accessing data with the vertex shader unit via a plurality of data buses; (3) a bank interleaving controller, for achieving byte alignment for the reconfigurable cache memory; (4) a software control data feedback, for reducing accessing frequency of registers of the reconfigurable cache memory; and (5) a software control data write back, for determining if the data need to be written back to the registers. Wherein the reconfigurable cache memory, comprises: a plurality of banks, for storing data; a plurality of channels, for logic mapping to the banks; a register file controller, for allocating suitable amount of registers of the banks to the each channel; and a plurality of buses, for transferring the data between the banks and the register file controller and between the channels and the register file controller.

The following detailed description, given by way of example and not intended to limit the invention solely to the embodiments described herein, will best be understood in conjunction with the accompanying drawings.

### BRIEF DESCRIPTION OF THE DRAWINGS

FIG. 1 is a block diagram of an application of a reconfigurable cache using in a GPU of the present invention.

FIG. 2 is a block diagram of the reconfigurable cache of FIG. 1 of the present invention.

FIGS. 3 and 4 are managing examples of the register file controller of the present invention.

FIG. 5 is a conceptual diagram for illustrating a linear address for addressing.

FIG. 6 is a conceptual diagram for illustrating an example of register files with and without bank interleaving.

FIG. 7 is a conceptual diagram for illustrating a byte alignment achieved by extending the linear address.

FIG. 8 is a conceptual diagram for illustrating a word alignment mode without the bank interleaving.

FIG. 9 is a conceptual diagram for illustrating a byte alignment mode with the bank interleaving.

FIG. 10 is a conceptual diagram for illustrating an example of the byte alignment mode with the bank interleaving.

FIG. 11 is a conceptual diagram for illustrating decoding modes with the bank interleaving.

FIG. 12 is a conceptual diagram for illustrating a hardware with 2 way VLIW instruction sets.

### DETAILED DESCRIPTION OF THE PREFERRED EMBODIMENTS

The present invention discloses graphics processing unit instruction sets using a reconfigurable cache that have video acceleration capability and are applicable to a portable hand-help device, such as, but not limited to, Digital Still Camera (DSC), Digital Video (DV), Personal Digital Assistant (PDA), mobile electronic device, 3G mobile phone, cellular phone or smart phone.

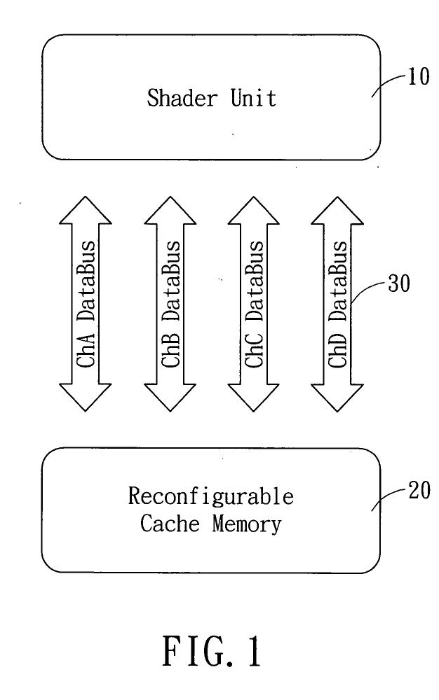

FIG. 1 is a block diagram of an application of a reconfigurable cache using in a GPU of the present invention. As shown in FIG. 1, a vertex shader unit 10 access data with the reconfigurable cache memory 20 via four data buses 30. The vertex shader unit 10 is used for operating vertex data and related statuses of the vertex data. The reconfigurable cache memory 110 achieves the essential architecture of all registers of the GPU by using a register file controller and several chips of static random access memories (SRAMs).

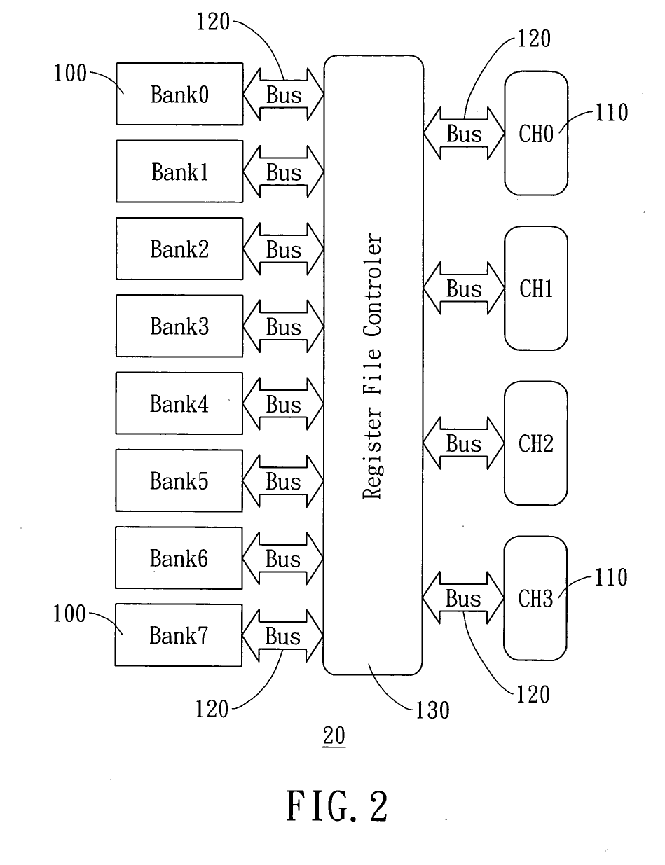

FIG. 2 is a block diagram of the reconfigurable cache of FIG. 1 of the present invention. As shown in FIG. 2, the reconfigurable cache 20 includes eight individual SRAMs constituting eight banks 100, from Bank0 to Bank7, four channels 110, from CH0 to CH3, several buses 120 and a register file controller 130. The each bank 100 is a separate working SRAM. The each channel 110 can be a set of required registers of the GPU. The four channels 110 can be a set of vertex input registers (CH0), a set of vertex output registers (CH1), a set of constant registers (CH2) and a set of temporary registers (CH3) respectively, thus provide all requirements for the GPU. The buses 120 are used for transferring data between the banks 100 and the register file controller 130 and between the channels 110 and the register file controller 130. The register file controller 130 is used for allocating suitable amount of registers to the each channel resulting in most working efficiency for the all registers.

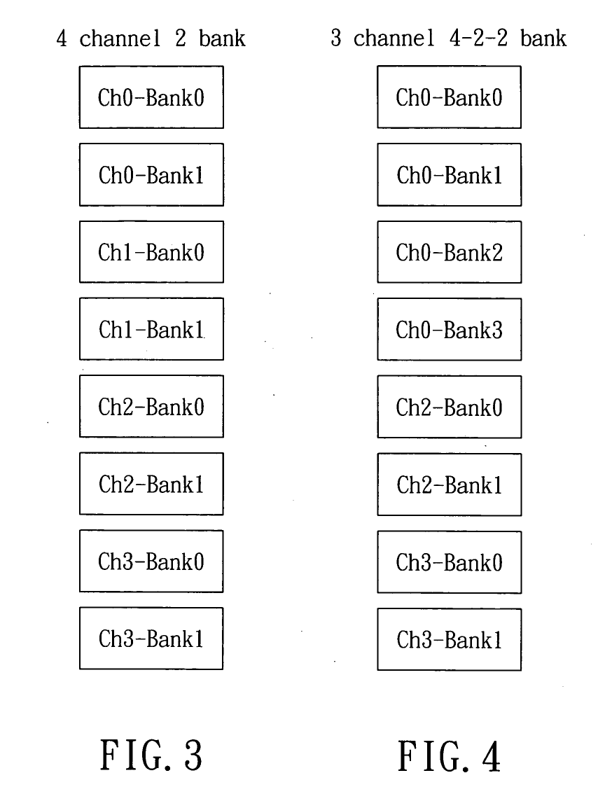

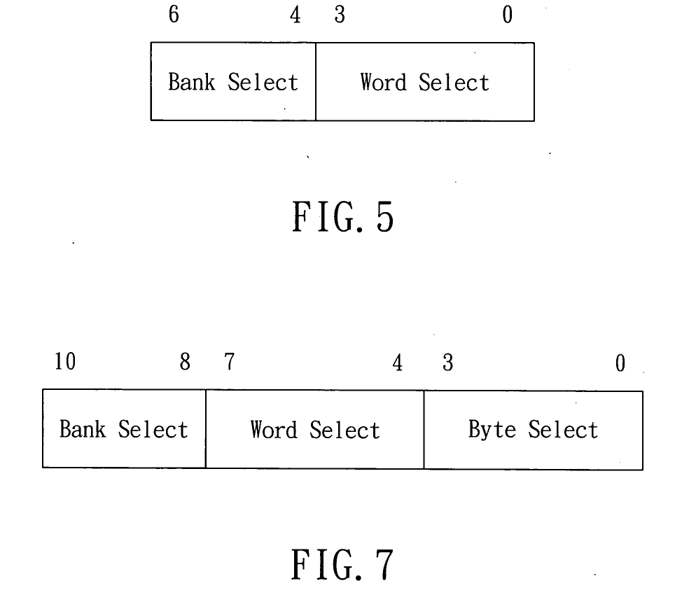

FIGS. 3 and 4 are managing examples of the register file controller of the present invention. As shown in FIG. 3, the each channel, from CH0 to CH3, is allocated two banks by the register file controller 130, respectively. As shown in FIG. 4, CH0 is allocated four banks, CH2 two banks, and CH3 two banks by the register file controller 130. There are eight banks, that is eight SRAMs, and the each bank has sixteen words so three bits are required for addressing to select suitable amount of the banks. There are sixteen words in each bank so four bits are required for addressing. For addressing to all registers, seven bits are required. A linear address for addressing is illustrated in FIG. 5.

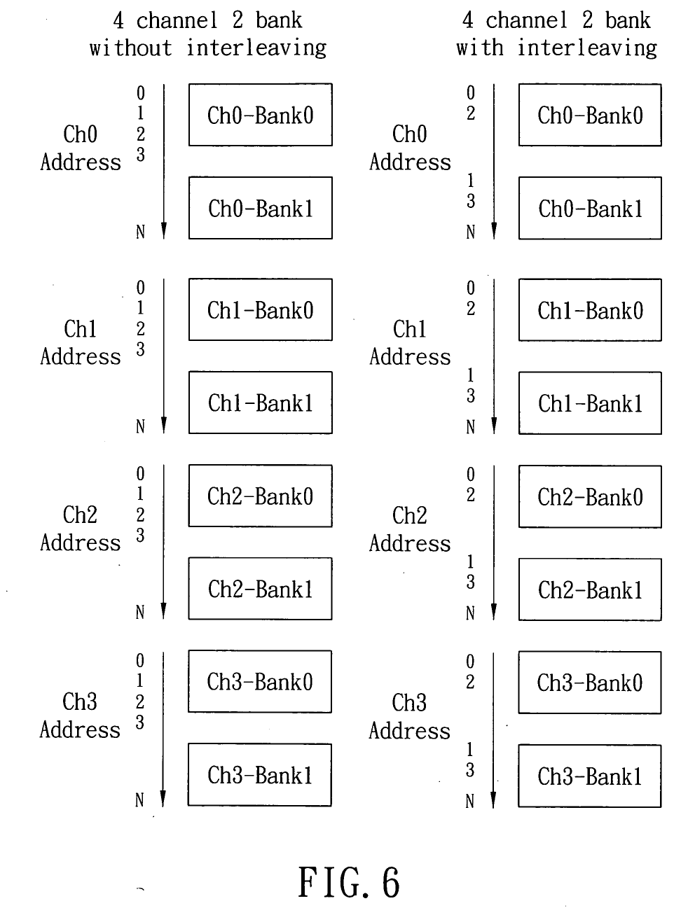

The register file controller 130 also has a bank interleaving module, as shown in FIG. 6. Without using the bank interleaving, data of a next linear address (LA+1) for a linear address (LA) can appear in the same bank, as shown in left of FIG. 6. By using the bank interleaving, data of the next linear address (LA+1) for the linear address (LA) can appear in another bank, as shown in right of FIG. 6. Data of odd addresses can be put in the same bank and of even addresses be put in the same bank. Thus, with the bank interleaving, the GPU can achieves several rd/wt ports in a set of registers.

The bank interleaving can achieve byte alignment. The linear address illustrated in FIG. 5 only achieves word alignment. But, many calculations require validity of byte alignment. The byte alignment can be easily achieved by extending the linear address, as shown in FIG. 7.

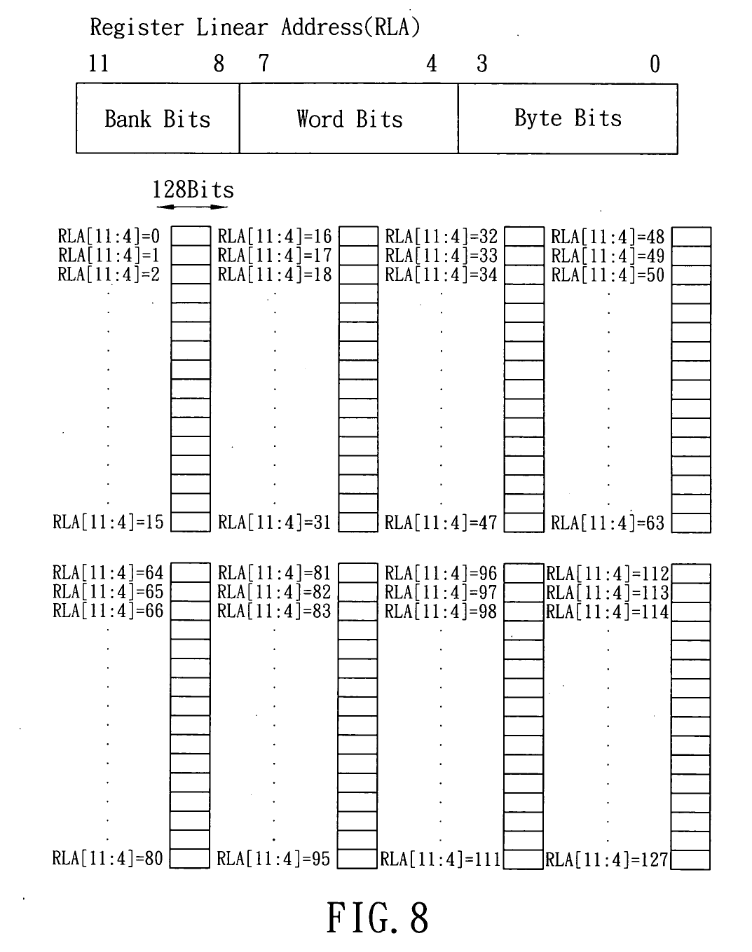

FIG. 8 is a conceptual diagram for illustrating a word alignment mode without the bank interleaving. Register linear address (RLA)[11:4] in the FIG. 8 represents only 11th to 4th bits to can be seen and 3rd to 0th bits not be seen. The 3rd to 0th bits represents data of 0-15 bytes and the databus illustrated in the invention is 128 bits, that is 16 bytes can be acquired in one time. Thus, without using the bank interleaving, the 3rd to 0th bits of complete RLA [11:0] do not affect addressing to SRAMs when the addresses of the registers are received. As shown in FIG. 8, data are in the same bank when data of 128 bits, that is RLA [11:4]+1, are acquired. And so forth, data are in another bank when data of 128 bits of fifteen sections are acquired completely. One channel with eight banks is illustrated in FIG. 8. Sixteen bytes alignment is required when data are acquired in each time. Although sixteen bytes' data can be acquired in one time, 1st to 16th bytes cannot be acquired; only 16th to 31st bytes are acquired after 0th to 15th bytes. 0th to 15th bytes are in the same word and 16th to 31st bytes in next word but all in the same bank; so desirable data cannot be acquired in one time.

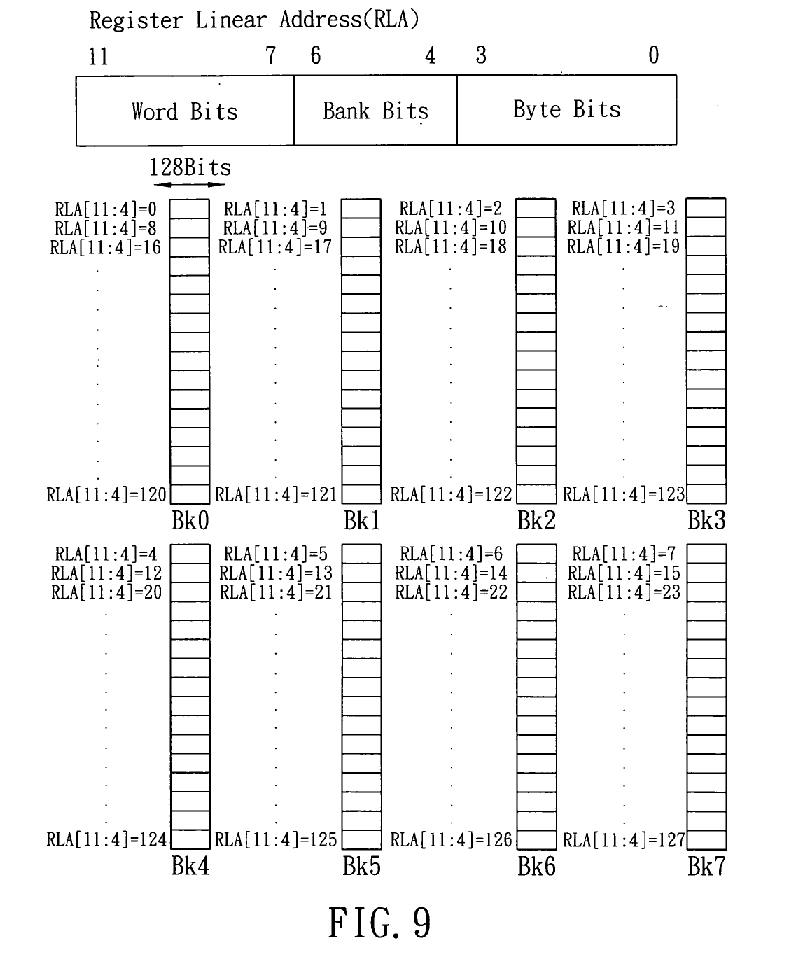

FIG. 9 is a conceptual diagram for illustrating a byte alignment mode with the bank interleaving. With using the bank interleaving, next 16 bytes' data are put in next bank. RLA [11:4]=0 and RLA [11:4]=1 are in different bank. There are eight banks in FIG. 9, thus 16 bytes' data of eight continuous sections are in different banks. Then, back to first bank, remaining data are put.

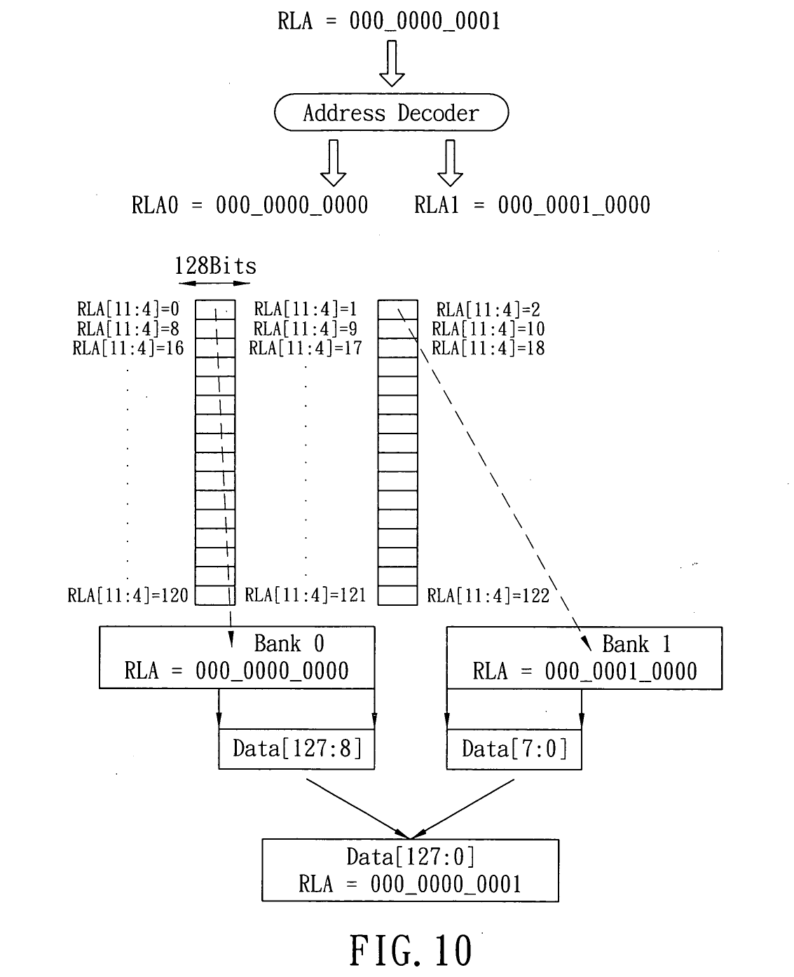

FIG. 10 is a conceptual diagram for illustrating an example of the byte alignment mode with the bank interleaving. With using the bank interleaving, two different banks can be accessed by the register file controller 130 at the same time when data of 1st to 16th bytes are acquired. Wherein, data of 0th to 15th bytes are acquired by the first bank and 16th to 31st bytes acquired by the next bank. Meanwhile, an access of byte alignment is achieved through assembling the data of the two banks.

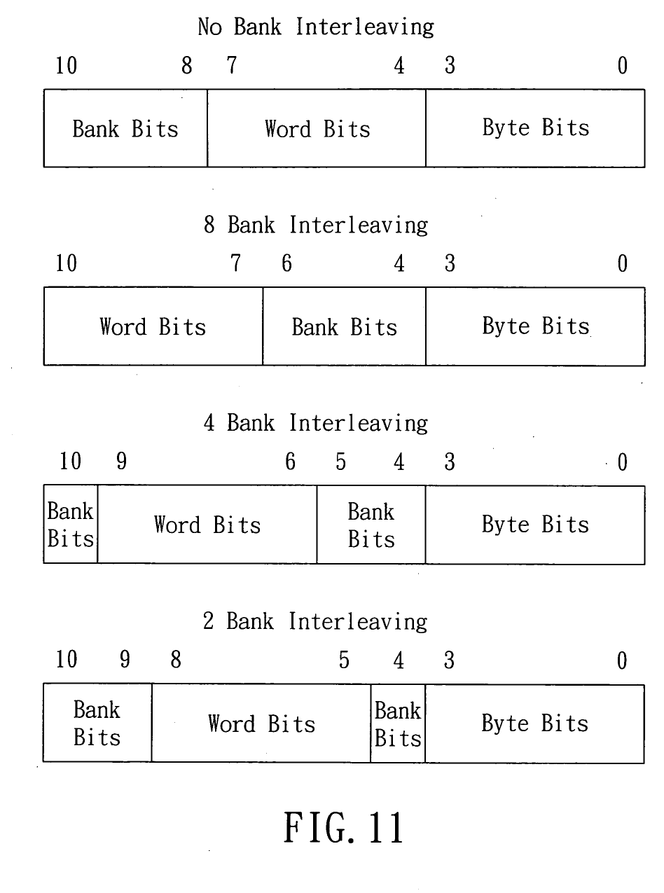

FIG. 11 is a conceptual diagram for illustrating decoding modes with the bank interleaving. In no bank interleaving mode, 0th to 3rd address data of previous 16 bytes. However, data bus of the present invention can acquire 16 bytes' data at one time essentially. Therefore, in this mode, the 0th to 3rd bits do not affect acquiring data, 4th to 7th bits are just used for selecting which word (128 bits) of which SRAM and 8th to 10th bits for selecting which bank. In eight bank interleaving mode, 0th to 3rd are denoted as the beginning position of 128 bits. 4th to 6th bits are decoded to access which banks and 7th to 10th bits to access which words of which banks. Likewise, in four bank interleaving mode, 0th to 3rd are denoted as the beginning position of 128 bits. 4th to 5th bits are decoded to access which banks of the four bank and 6th to 9th bits to access which words of which banks. 10th bit is decoded to access another four bank. For eight SRAMs in the system, two sets of four SRAMs of banks exist when four bank interleaving mode is performed. 10th bit is decoded to access another set of four banks. In two bank interleaving mode, 0th to 3rd are denoted as the beginning position of 128 bits. 4th bit is decoded to access which banks, 5th to 8th bits to access which words of which banks and 9th to 10th bits to access another four sets of two banks.

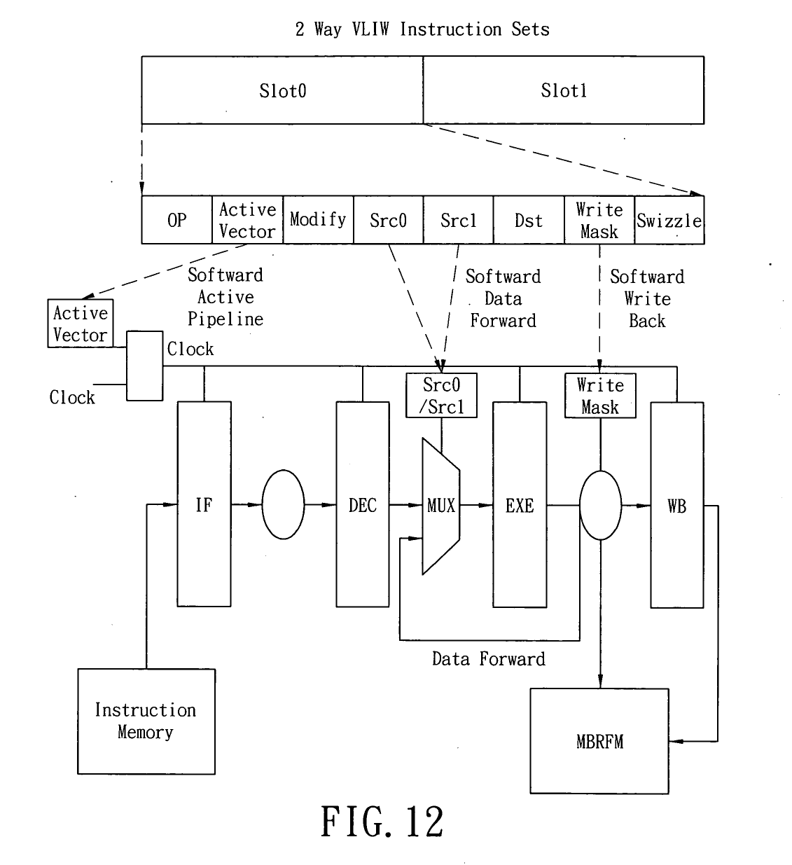

The graphics processing unit instruction sets of the present invention further includes a software control data feedback for reducing accessing frequency of the registers resulting in saving power consumption. The graphics processing unit instruction sets of the present invention also includes a software control data write back for determining if data need to be written back to the registers resulting in saving the power for writing back to the registers. FIG. 12 is a conceptual diagram for illustrating a hardware with 2 way VLIW instruction sets. The 2 way VLIW represents Very Long Instruction Word which can send out two instructions at a time. Slot0 represents an instruction and Slot1 represents another; Slot0 and Slot1 are combined as a VLIW instruction. A format of each Slot instruction includes OP, Active Vector, Modify, Src0, Src1, Dst, White Mask and Swizzle fields. The Active Vector is used for allocating how many vectors needed to be launched for calculation. The vector calculation, for example, Vector1(x,y,z,w)×Vector2(x,y,z,w) can achieve four dimension vector calculation and Vector1(x,y,)×Vector2(x,y,) achieve only two dimension. The Src0 and Src1 are INPUT Source fields. Some values are defined and given to certain inner registers to achieve the software control data feedback. For example,
r0=r1×c1;
o0=r0+c2,

wherein r0, r1, c1, o0 and c2 represents Register 0, Register 1, Constant 1, Output register o0 and Constant 2, respectively, a multiplying instruction is employed to multiply Register 1 and Constant 1 together, then the result is stored into Register 0; Output register o0 equals to add Register 0 and Constant 2 together.

Via a software compiler, the two equations can be rewritten as following,
NoDst=r1×c1;
o0=Mul_Reg+c2,

NoDst label means the multiply instruction performs multiplying Register 1 and Constant 1 together, and the result need not be stored into Register 0; Mul_Reg label means the addition instruction performs an addition directly using a value of a register of an inner multiplying device. Thus it can be seen that NoDst resolves the software control data write back and Mul_Reg resolves the software control data feedback.

The graphics processing unit instruction sets of the present invention further includes a sum of absolute difference (SAD) instruction using the cache memory of the GPU as a search range buffer and customizing calculating units of the GPU for achieving hardware resource sharing.

What is claimed is:

1. Graphics processing unit instruction sets using a reconfigurable cache, comprising:
a vertex shader unit, for operating vertex data;
a reconfigurable cache memory, for accessing data with the vertex shader unit via a plurality of data buses;
a bank interleaving, for achieving byte alignment for the reconfigurable cache memory;
a software control data feedback, for reducing accessing frequency of registers of the reconfigurable cache memory; and
a software control data write back, for determining if the data need to be written back to the registers;
wherein the reconfigurable cache memory, comprises:
a plurality of banks, for storing data;
a plurality of channels, for logic mapping to the banks;
a register file controller, for allocating suitable amount of registers of the banks to the each channel; and
a plurality of buses, for transferring the data between the banks and the register file controller and between the channels and the register file controller.

2. The graphics processing unit instruction sets as recited in claim 1, wherein the each bank is a separate working static random access memory.

3. The graphics processing unit instruction sets as recited in claim 1, wherein the each channels can be a set of vertex input registers, a set of vertex output registers, a set of constant registers or a set of temporary registers.

4. A reconfigurable cache memory using in a graphics processing unit, comprising:
a plurality of banks, for storing data;
a plurality of channels, for logic mapping to the banks;
a register file controller, for allocating suitable amount of registers of the banks to the each channel;
a plurality of buses, for transferring the data between the banks and the register file controller and between the channels and the register file controller; and
a bank interleaving controller, for achieving byte alignment for the reconfigurable cache memory.

5. The reconfigurable cache memory as recited in claim 4, wherein the each bank is a separate working static random access memory.

6. The reconfigurable cache memory as recited in claim 4, wherein the each channels can be a set of vertex input registers, a set of vertex output registers, a set of constant registers or a set of temporary registers.
